(19) United States
(12) Patent Application Publication
(10) Pub. No.: US 2025/0246349 A1
(43) Pub. Date: Jul. 31, 2025

(54) COIL COMPONENT

(71) Applicant: TDK Corporation, Tokyo (JP)

(72) Inventors: Yusuke NAGAI, Tokyo (JP); Takahiro SATO, Tokyo (JP); Makoto YOSHINO, Tokyo (JP); Hidenobu UMEDA, Tokyo (JP); Shinichi SATO, Tokyo (JP); Yuya ISHIMA, Tokyo (JP); Keito YASUDA, Tokyo (JP)

(73) Assignee: TDK Corporation, Tokyo (JP)

(21) Appl. No.: 18/985,348

(22) Filed: Dec. 18, 2024

(30) Foreign Application Priority Data
Jan. 30, 2024 (JP) 2024-011949

(51) Int. Cl. H01F 5/04; H01F 27/29

(52) U.S. Cl. CPC H01F 5/04; H01F 27/292

(57) ABSTRACT

A first coil conductor includes a first portion adjacent to a first side surface. A second coil conductor includes a second portion adjacent to a second side surface and a third portion arranged such that the first portion is positioned between the third portion and the first side surface. A third coil conductor includes a fourth portion adjacent to the second side surface and arranged to overlap with the second portion in a direction perpendicular to a main surface. A fourth coil conductor includes a fifth portion adjacent to the first side surface and arranged to overlap with the first portion in the direction and a sixth portion arranged to overlap with the third portion in the direction and such that the fourth portion is positioned between the sixth portion and the second side surface. The third and sixth portions are connected through a connection conductor.

### CROSS-REFERENCE TO RELATED APPLICATIONS

This application is based upon and claims the benefit of priority from Japanese Patent Application No. 2024-011949, filed on Jan. 30, 2024, the entire contents of which are incorporated herein by reference.

### BACKGROUND

### Field

The present disclosure relates to a coil component.

### Description of the Related Art

Known coil components include an element body, a first external electrode and a second external electrode disposed on the element body, and a coil disposed in the element body (for example, refer to Japanese Unexamined Patent Publication No. 2011-009391). The element body includes, for example, a first main surface, a second main surface opposing the first main surface, and a plurality of side surfaces coupling the first main surface and the second main surface. The first external electrode and the second external electrode are, for example, disposed on the first main surface and are separated from each other. The coil includes, for example, a plurality of coil conductor layers electrically connected to the first external electrode and the second external electrode.

### SUMMARY

One aspect of the present disclosure provides a coil component that may increase the number of turns of a coil as well as an inner diameter of the coil.

A coil component according to one aspect of the present disclosure includes: an element body including a first main surface, a second main surface opposing the first main surface, and a plurality of side surfaces coupling the first main surface and the second main surface; a first external electrode and a second external electrode disposed on the first main surface and separated from each other; and a coil disposed in the element body and including a plurality of coil conductor layers electrically connected to the first external electrode and the second external electrode. The plurality of side surfaces include a first side surface and a second side surface next to each other. The plurality of coil conductor layers include: a first coil conductor layer including a first coil conductor and a second coil conductor separated from each other; and a second coil conductor layer adjacent to the first coil conductor layer in a direction perpendicular to the first main surface and including a third coil conductor and a fourth coil conductor separated from each other. The first coil conductor includes a first portion adjacent to the first side surface and arranged to extend along the first side surface. The second coil conductor includes: a second portion adjacent to the second side surface and arranged to extend along the second side surface; and a third portion continuous with the second portion and arranged to extend such that the first portion is positioned between the third portion and the first side surface. The third coil conductor includes a fourth portion adjacent to the second side surface and arranged to extend to overlap with the second portion in the direction perpendicular to the first main surface. The fourth coil conductor includes: a fifth portion adjacent to the first side surface and arranged to extend to overlap with the first portion in the direction perpendicular to the first main surface; and a sixth portion continuous with the fifth portion and arranged to extend to overlap with the third portion in the direction perpendicular to the first main surface and to extend such that the fourth portion is positioned between the sixth portion and the second side surface. The third portion and the sixth portion are connected through a connection conductor.

In the one aspect described above, the coil includes the first coil conductor layer and the second coil conductor layer. The first coil conductor layer includes the first coil conductor and the second coil conductor. The second coil conductor layer includes the third coil conductor and the fourth coil conductor. Each of the first and second coil conductor layers included in the coil includes the above-described coil conductors electrically connected to the first external electrode and the second external electrode. The one aspect described above may increase the number of turns of the coil.

In the one aspect described above, the first portion is arranged to extend along the first side surface, and the fifth portion is arranged to extend to overlap with the first portion in the direction perpendicular to the first main surface. The second portion is arranged to extend along the second side surface, and the fourth portion is adjacent to the second side surface and is arranged to extend to overlap with the second portion in the direction perpendicular to the first main surface. The one aspect in which the first, second, fourth, and fifth portions are arranged to extend as described above may increase an inner diameter of the coil. In the one aspect described above, the third portion is arranged to extend such that the first portion is positioned between the third portion and the first side surface, and the sixth portion is arranged to extend such that the fourth portion is positioned between the sixth portion and the second side surface. Therefore, the one aspect described above reliably maintains a connection between the first portion and the fourth portion.

In the one aspect described above, the first portion and the fourth portion may be connected through a connection conductor.

A configuration in which the first portion and the fourth portion are connected through the connection conductor reliably maintains a connection between the first portion and the fourth portion.

In the one aspect described above, the plurality of side surfaces may include a third side surface opposing the first side surface and a fourth side surface opposing the second side surface. The plurality of coil conductor layers may include an other coil conductor layer including a fifth coil conductor and a sixth coil conductor that are separated from each other, the other coil conductor layer being disposed adjacent to the first coil conductor layer in the direction perpendicular to the first main surface and being disposed such that the first coil conductor layer is positioned between the other coil conductor layer and the second coil conductor layer. The second coil conductor may include a seventh portion continuous with the second portion, the seventh portion being adjacent to the third side surface and arranged to extend along the third side surface. The first coil conductor may include: an eighth portion continuous with the first portion, the eighth portion being adjacent to the fourth side surface and arranged to extend along the fourth side surface; and a ninth portion continuous with the eighth portion and arranged to extend such that the seventh portion is positioned between the ninth portion and the third side surface. The fifth coil conductor may include a tenth portion adjacent to the fourth side surface and arranged to extend to overlap with the eighth portion in the direction perpendicular to the first main surface. The sixth coil conductor may include: an eleventh portion adjacent to the third side surface and arranged to extend to overlap with the seventh portion in the direction perpendicular to the first main surface; and a twelfth portion continuous with the eleventh portion and arranged to extend to overlap with the ninth portion in the direction perpendicular to the first main surface and to extend such that the tenth portion is positioned between the twelfth portion and the fourth side surface. The ninth portion and the twelfth portion may be connected through a connection conductor.

A configuration in which the second coil conductor includes the seventh portion and the first coil conductor includes the eighth portion and the ninth portion may further increase the inner diameter of the coil. A configuration in which the fifth coil conductor includes the tenth portion and the sixth coil conductor includes the eleventh portion and the twelfth portion may further increase the inner diameter of the coil.

In the one aspect described above, the seventh portion and the tenth portion may be connected through a connection conductor.

A configuration in which the seventh portion and the tenth portion are connected through the connection conductor reliably maintains a connection between the seventh portion and the tenth portion.

In the one aspect described above, the plurality of coil conductor layers may include a third coil conductor layer including a pair of coil conductors that are separated from each other, the third coil conductor layer being adjacent to the first main surface. One coil conductor of the pair of coil conductors may be positioned at one end of the coil and be connected to the first external electrode through a connection conductor, and an other coil conductor of the pair of coil conductors may be positioned at an other end of the coil and be connected to the second external electrode through a connection conductor.

In a configuration in which the one coil conductor of the pair of coil conductors is positioned at the one end of the coil and is connected to the first external electrode through the connection conductor, and the other coil conductor of the pair of coil conductors is positioned at the other end of the coil and is connected to the second external electrode through the connection conductor, the connection conductor arranged to connect the one coil conductor to the first external electrode and the connection conductor arranged to connect the other coil conductor to the second external electrode may have a thickness in the direction perpendicular to the first main surface that is smaller than a thickness in the direction perpendicular to the first main surface of each coil conductor. A decrease in thicknesses of the connection conductor arranged to connect the one coil conductor to the first external electrode and the connection conductor arranged to connect the other coil conductor to the second external electrode in the direction perpendicular to the first main surface may more reliably increase the number of the turns of the coil.

In the one aspect described above, a distance between the one coil conductor and the first external electrode in the direction perpendicular to the first main surface and a distance between the other coil conductor and the second external electrode in the direction perpendicular to the first main surface may be equal to each other.

A configuration in which the distances are equal to each other may make a length of the connection conductor arranged to connect the one coil conductor and the first external electrode in the direction perpendicular to the first main surface equal to a length of the connection conductor arranged to connect the other coil conductor and the second external electrode in the direction perpendicular to the first main surface.

In the one aspect described above, the connection conductor arranged to connect the one coil conductor and the first external electrode and the connection conductor arranged to connect the other coil conductor and the second external electrode may be next to one side surface of the plurality of side surfaces.

A configuration in which the connection conductor arranged to connect the one coil conductor and the first external electrode and the connection conductor arranged to connect the other coil conductor and the second external electrode are next to the one side surface may increase a length of each coil conductor, as compared with, for example, a configuration in which each of the connection conductor arranged to connect the one coil conductor and the first external electrode and the connection conductor arranged to connect the other coil conductor and the second external electrode is next to different side surfaces. Therefore, a configuration in which the connection conductor arranged to connect the one coil conductor and the first external electrode and the connection conductor arranged to connect the other coil conductor and the second external electrode are next to the one side surface may improve inductance of the coil.

### BRIEF DESCRIPTION OF THE DRAWINGS

FIG. 1 is a perspective view of a coil component according to an example;

FIG. 2 is a view illustrating a cross-sectional configuration of the coil component according to the example;

FIG. 3 is an exploded perspective view illustrating a coil and a connection conductor;

FIG. 4 is a view illustrating a cross-sectional configuration of the coil component according to the example;

FIG. 5 is a view illustrating a cross-sectional configuration of the coil component according to the example;

FIG. 6 is a view illustrating a cross-sectional configuration of the coil component according to the example;

FIG. 7 is an exploded perspective view illustrating a coil and a connection conductor; and

FIG. 8 is a view illustrating a cross-sectional configuration of a coil component according to a modified example of the example.

### DETAILED DESCRIPTION

In the following description, with reference to the drawings, the same reference numbers are assigned to the same components or to similar components having the same function, and overlapping description is omitted.

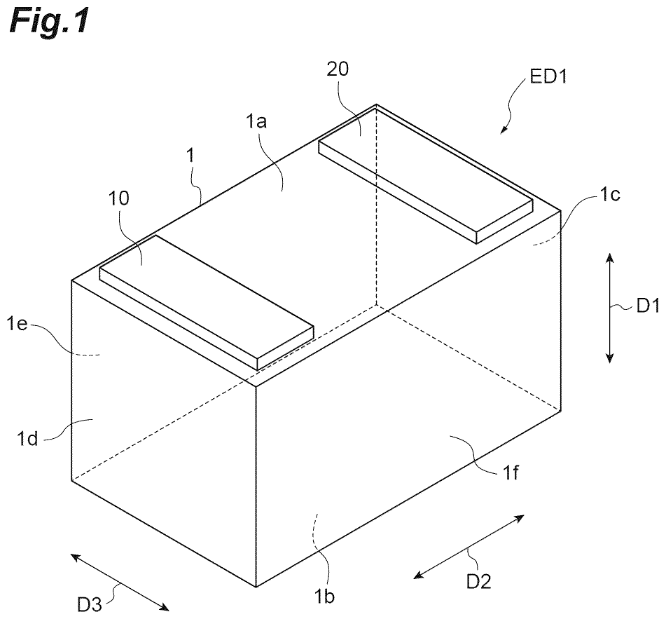

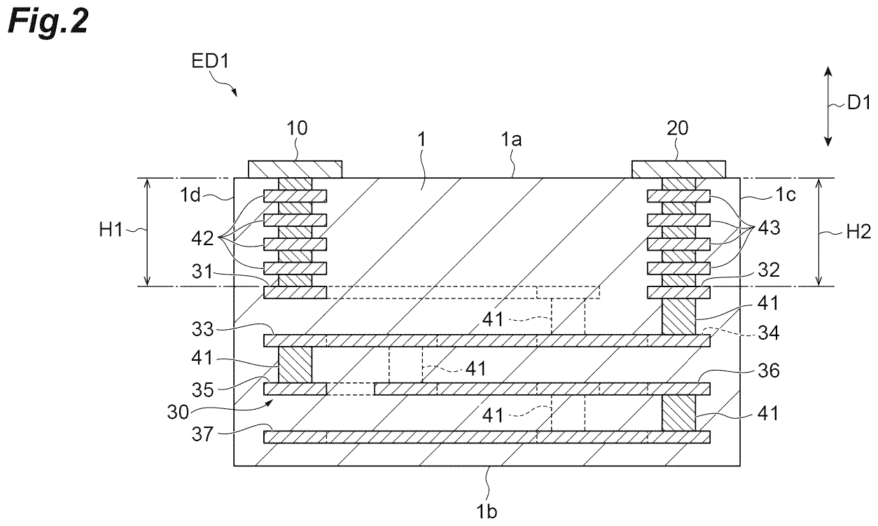

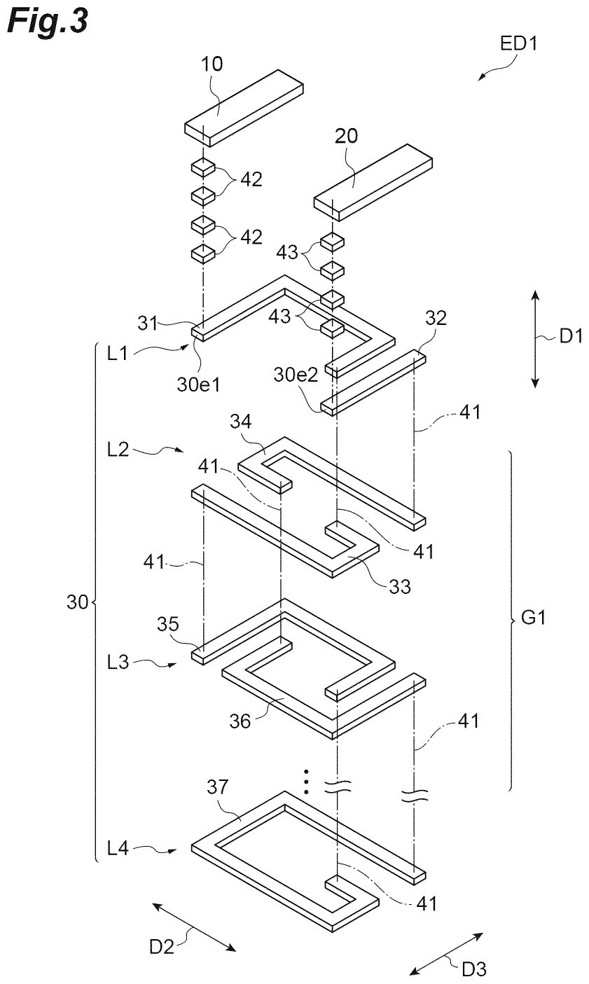

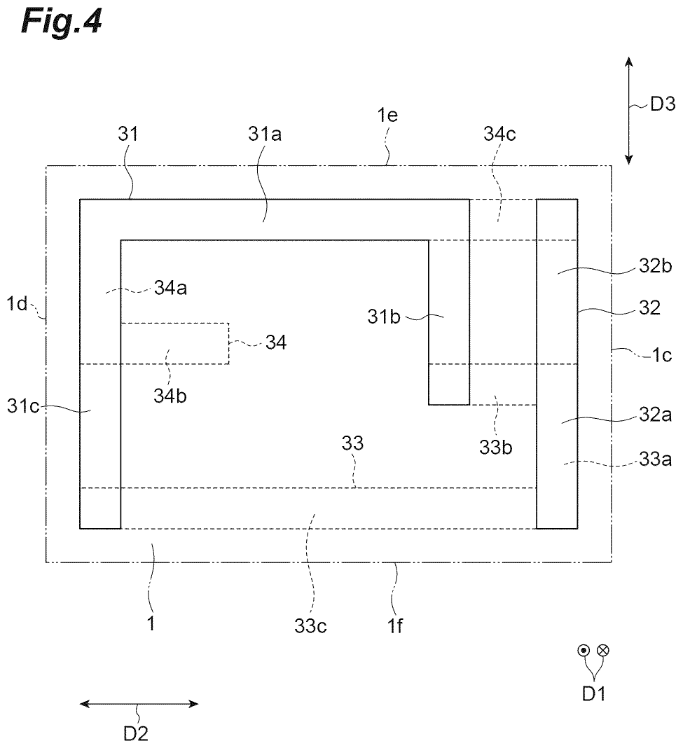

A configuration of a coil component ED1 according to an example will be described with reference to FIGS. 1 to 6. FIG. 1 is a perspective view of a coil component according to the example. FIG. 2 is a view illustrating a cross-sectional configuration of the coil component according to the example. FIG. 3 is an exploded perspective view illustrating a coil and a connection conductor. FIGS. 4, 5, and 6 are views illustrating cross-sectional configurations of the coil component according to the example.

As illustrated in FIGS. 1 and 2, the coil component ED1 includes an element body 1, external electrodes 10 and 20, and a coil 30. The external electrodes 10 and 20 are disposed on an outer surface of the element body 1. The coil 30 is disposed in the element body 1 and is electrically connected to the external electrodes 10 and 20. For example, the coil 30 is disposed such that a coil axis extends along a first direction D1. In FIG. 1, the coil 30 is not illustrated. In FIG. 3, the element body 1 is not illustrated.

The element body 1 has, for example, a rectangular parallelepiped shape. The rectangular parallelepiped shape includes a rectangular parallelepiped shape in which corners and ridges are chamfered, or a rectangular parallelepiped shape in which the corners and ridges are rounded. The element body 1 includes a pair of main surfaces 1a and 1b opposing each other, and a plurality of side surfaces 1c, 1d, 1e, and 1f coupling the pair of main surfaces 1a and 1b. For example, the outer surfaces of the element body 1 include a pair of main surfaces 1a and 1b and four side surfaces 1c, 1d, 1e, and 1f.

The element body 1 includes, for example, a plurality of insulator layers having electrical insulation. For example, the element body 1 includes a plurality of insulator layers laminated in the first direction D1. The plurality of insulator layers are integrated to such an extent that boundaries between the insulator layers cannot be visually recognized. Each of the plurality of insulator layers has, for example, a rectangular shape when viewed from the first direction D1.

Each insulator layer includes a plurality of metal magnetic particles. The metal magnetic particles are made of, for example, a soft magnetic alloy. The soft magnetic alloy includes, for example, an Fe—Si alloy. In a configuration in which the soft magnetic alloy includes an Fe—Si alloy, the soft magnetic alloy may include P. The soft magnetic alloy may include, for example, an Fe—Ni—Si-M alloy. “M” includes at least one element selected from Co, Cr, Mn, P, Ti, Zr, Hf, Nb, Ta, Mo, Mg, Ca, Sr, Ba, Zn, B, Al, and rare earth elements. In the insulator layer, the metal magnetic particles are bonded to each other. The metal magnetic particles are bonded to each other through, for example, bonding of oxide films formed on surfaces of the metal magnetic particles. The element body 1 includes resin. The resin exists between the plurality of metal magnetic particles. The resin is a resin having electrical insulation, that is, electrical insulating resin. Examples of the electrical insulating resin include a silicone resin, a phenol resin, an acrylic resin, and an epoxy resin.

The insulator layer may include a glass ceramic material or a dielectric material. The glass ceramic material includes, for example, glass and alumina. The glass included in the glass-ceramic material includes, for example, strontium, calcium, alumina, and silicon oxide.

For example, the main surface 1a is arranged to constitute a mounting surface. The main surface 1a includes the mounting surface. The main surface 1a opposes an electronic device when mounted on the electronic device. The electronic device includes, for example, a circuit board or a multilayer electronic component. The main surface 1b may be arranged to constitute the mounting surface. Each of the pair of main surfaces 1a and 1b and the four side surfaces 1c, 1d, 1e, and 1f has, for example, a rectangular shape. The rectangular shape includes, for example, a rectangular shape in which corners are chamfered or a rectangular shape in which corners are rounded.

The pair of main surfaces 1a and 1b oppose each other in the first direction D1. The main surface 1a is perpendicular to the first direction D1. That is, the first direction D1 includes a direction perpendicular to the main surface 1a. The pair of side surfaces 1c and 1d oppose each other in a second direction D2. The pair of side surfaces 1e and 1f oppose each other in a third direction D3. The four side surfaces 1c, 1d, 1e, and 1f are arranged to extend in the first direction D1 to couple the pair of main surfaces 1a and 1b. The pair of side surfaces 1c and 1e are adjacent to each other. The pair of side surfaces 1d and 1f are adjacent to each other. The first direction D1 intersects with the second direction D2 and intersects with the third direction D3. The second direction D2 intersects, for example, the third direction D3. For example, the first direction D1, the second direction D2, and the third direction D3 are perpendicular to each other.

For example, when the main surface 1a includes a first main surface, the main surface 1b includes a second main surface. For example, when the side surface 1f includes a first side surface, the side surface 1d includes a second side surface. For example, when the side surface 1f includes a first side surface, the side surface 1e includes a third side surface. For example, when the side surface 1d includes a second side surface, the side surface 1c includes a fourth side surface.

A length of the element body 1 in the first direction D1 is, for example, 0.05 to 2.0 mm. A length of the element body 1 in the second direction D2 is, for example, 0.05 to 4.0 mm. A length of the element body 1 in the third direction D3 is, for example, 0.05 to 4.0 mm. In the element body 1, for example, the second direction D2 is a longitudinal direction.

The external electrodes 10 and 20 are disposed on the main surface 1a of the pair of main surfaces 1a and 1b. For example, the external electrodes 10 and 20 are joined to terminals of the electronic device when mounting the coil component ED1. The external electrodes 10 and 20 are separated from each other in the second direction D2 and are electrically connected to the coil 30. When viewed from the first direction D1, the external electrodes 10 and 20 are separated from four ends of the element body 1. Each of the four ends of the element body 1 overlaps with a corresponding side surface of the four side surfaces 1c, 1d, 1e, and 1f, when viewed from the first direction D1. For example, the external electrodes 10 and 20 protrude from the main surface 1a. The external electrodes 10 and 20 have, for example, a rectangular parallelepiped shape. For example, when the external electrode 10 includes a first external electrode, the external electrode 20 includes a second external electrode.

The external electrodes 10 and 20 include an electrically conductive material. The electrically conductive material includes, for example, Ag, Pd, Cu, or Al. The electrically conductive material includes, for example, an Ag—Pd alloy, an Ag—Cu alloy, an Ag—Au alloy, or an Ag—Pt alloy. The external electrodes 10 and 20 include, for example, a Ni plating film, a Sn plating film, a Cu plating film, or an Au plating film. The external electrodes 10 and 20 may have a multilayer structure of these plating films, and may include the Ni plating film and the Sn plating film on the Ni plating film. Each thickness of portions, of the external electrodes 10 and 20, positioned on the main surface 1a is, for example, 1 to 50 μm.

As illustrated in FIG. 3, the coil 30 includes a plurality of coil conductor layers L1, L2, L3, and L4. The plurality of coil conductor layers L1, L2, L3, and L4 are disposed in the element body 1 and are electrically connected to the external electrodes 10 and 20. The coil conductor layer L1 is adjacent to the main surface 1a. The coil conductor layer L2 is adjacent to the coil conductor layer L1 in the first direction D1. The coil conductor layer L3 is adjacent to the coil conductor layer L2 in the first direction D1. The coil conductor layer L4 is adjacent to the coil conductor layer L3 in the first direction D1. For example, the coil conductor layer L1 includes coil conductors 31 and 32, and the coil conductor layer L2 includes coil conductors 33 and 34. The coil conductor layer L3 includes coil conductors 35 and 36, and the coil conductor layer L4 includes a coil conductor 37.

For example, when the coil conductor layer L2 includes a first coil conductor layer, the coil conductor layer L3 includes a second coil conductor layer, and the coil conductor layer L1 includes a third coil conductor layer. For example, when the coil conductor layer L2 includes a first coil conductor layer, the coil conductor layer L1 may include an other coil conductor layer.

The coil conductors 31 to 37 are disposed in the element body 1. The coil conductors 31 to 37 are disposed in the first direction D1. Corresponding coil conductors, among the coil conductors 31 to 37, adjacent to each other in the first direction D1 are connected to each other. The coil conductors 31 to 37 are electrically connected to each other. The above-described corresponding coil conductors are disposed to at least partially overlap each other when viewed from the first direction D1. The coil 30 includes, for example, a coil conductor of a shape in which a part of a loop is interrupted. The coil 30 includes, for example, a coil conductor that includes a pair of ends and has a shape substantially along an annular path from the one end to the other end. The coil 30 includes, for example, a coil conductor of a substantially rectangular shape.

For example, when the coil conductor 33 includes a first coil conductor, the coil conductor 34 includes a second coil conductor, the coil conductor 35 includes a third coil conductor, and the coil conductor 36 includes a fourth coil conductor. For example, when the coil conductor 33 and the coil conductor 34 include a first coil conductor and a second coil conductor, respectively, the coil conductor 32 includes a fifth coil conductor, and the coil conductor 36 includes a sixth coil conductor.

As illustrated in FIG. 3, the coil component ED1 includes a connection conductor 42 that connects the coil conductor 31 and the external electrode 10, and a connection conductor 43 that connects the coil conductor 32 and the external electrode 20. The coil 30 includes a pair of ends positioned closer to the main surface 1a. The connection conductor 42 is disposed at one end of the pair of ends of the coil 30, and the connection conductor 43 is disposed at an other end of the pair of ends of the coil 30. For example, the coil conductors 31 and 32 are the closest to the external electrodes 10 and 20 among the coil conductors included in the coil 30. The connection conductor 42 is connected to the coil conductor 31. The connection conductor 43 is connected to the coil conductor 32. The coil conductor 31 is positioned at one end 30e1 of the coil 30. The coil conductor 32 is positioned at an other end 30e2 of the coil 30. The connection conductors 42 and 43 include, for example, through-hole conductors. The connection conductors 42 and 43 may include through-hole conductors and pad conductors. For example, when the coil conductor 31 includes one coil conductor, the coil conductor 32 includes an other coil conductor.

The coil conductor 31 is connected to the external electrode 10. The coil conductor 31 is electrically connected to the external electrode 10. For example, the coil conductor 31 is electrically connected to the external electrode 20 through the connection conductor 42. The coil conductor 31 may be connected to the external electrode 10 through a through-hole conductor. The coil conductor 31 may be connected to the external electrode 10 through a single through-hole conductor. The coil conductor 32 is connected to the external electrode 20. The coil conductor 32 is electrically connected to the external electrode 20. For example, the coil conductor 32 is electrically connected to the external electrode 20 through the connection conductor 43. The coil conductor 32 may be connected to the external electrode 20 through a through-hole conductor. The coil conductor 32 may be connected to the external electrode 20 through a single through-hole conductor.

A distance H1 between the coil conductor 31 and the external electrode 10 in the first direction D1 and a distance H2 between the coil conductor 32 and the external electrode 20 in the first direction D1 are equal to each other. In this specification, “equal” does not necessarily mean only that values are identical. Even in the case in which a slight difference in a predetermined range, a manufacturing error, or a measurement error is included, it can be defined that values are equal to each other. For example, in the case in which each of values falls within a range of ±10% of an average value of the values, the values are defined to be equal to each other.

The connection conductor 42 includes a plurality of connection conductors 42. The connection conductors 42 adjacent to each other among the plurality of connection conductors 42 are connected to each other through, for example, a through-hole conductor. The connection conductor 42 farthest from the coil 30 is connected to the outer electrode 10 through, for example, a through-hole conductor. The connection conductor 42 closest to the coil 30 is connected to the coil 30 through, for example, a through-hole conductor.

The connection conductor 43 includes a plurality of connection conductors 43. The connection conductors 43 adjacent to each other among the plurality of connection conductors 43 are connected to each other through, for example, an other through-hole conductor. The connection conductor 43 farthest from the coil 30 is connected to the outer electrode 20 through, for example, an other through-hole conductor. The connection conductor 43 closest to the coil 30 is connected to the coil 30 through, for example, an other through-hole conductor.

The connection conductors 42 and 43 are next to one side surface of the side surfaces 1c, 1d, 1e, and 1f. For example, the connection conductors 42 and 43 are next to the side surface 1f rather than to the side surface 1e. The connection conductors 42 and 43 may be next to the side surface 1e rather than the side surface 1f.

The corresponding coil conductors adjacent to each other among the coil conductors 31 to 37 are connected to each other at respective ends of the corresponding coil conductors. The corresponding coil conductors adjacent to each other among the coil conductors 31 to 37 are electrically connected to each other at the respective ends of the corresponding coil conductors. The coil component ED1 includes, for example, a connection conductor 41. For example, the connection conductor 41 includes a plurality of connection conductors 41. The above-described corresponding coil conductors among the coil conductors 31 to 37 are electrically connected to each other through the connection conductor 41 at the respective ends of the corresponding coil conductors. The connection conductor 41 includes, for example, a through-hole conductor. The connection conductor 41 may include a through-hole conductor and a pad conductor.

As illustrated in FIG. 4, the coil conductor 31 includes a portion 31a, a portion 31b, and a portion 31c. The portion 31a is adjacent to the side surface 1e and is arranged to extend along the side surface 1e. The portion 31b is continuous with the portion 31a and is arranged to extend such that the portion 32b is positioned between the portion 31b and the side surface 1c. The portion 31c is continuous with the portion 31a. The portion 31c is adjacent to the side surface 1d and is arranged to extend along the side surface 1d. The portion 31c is closer to the side surface 1d than the portion 31b. The portion 31c is connected to the connection conductors 42. The portion 31c is connected to the connection conductors 42 through, for example, a through-hole conductor.

The coil conductor 32 includes a portion 32a and a portion 32b. The portion 32a is adjacent to the side surface 1c and is arranged to extend along the side surface 1c. The portion 32b is continuous with the portion 32a. The portion 32b is adjacent to the side surface 1c and is arranged to extend along the side surface 1c. The portion 32a is closer to the side surface 1f than the portion 32b. The portion 32b is connected to the coil conductor 34. The portion 32b is electrically connected to the coil conductor 34. The portion 32b is connected to the coil conductor 34 through the connection conductor 41. The portion 32a is connected to the connection conductor 43. The portion 32a is electrically connected to the connection conductor 43 through, for example, a through-hole conductor.

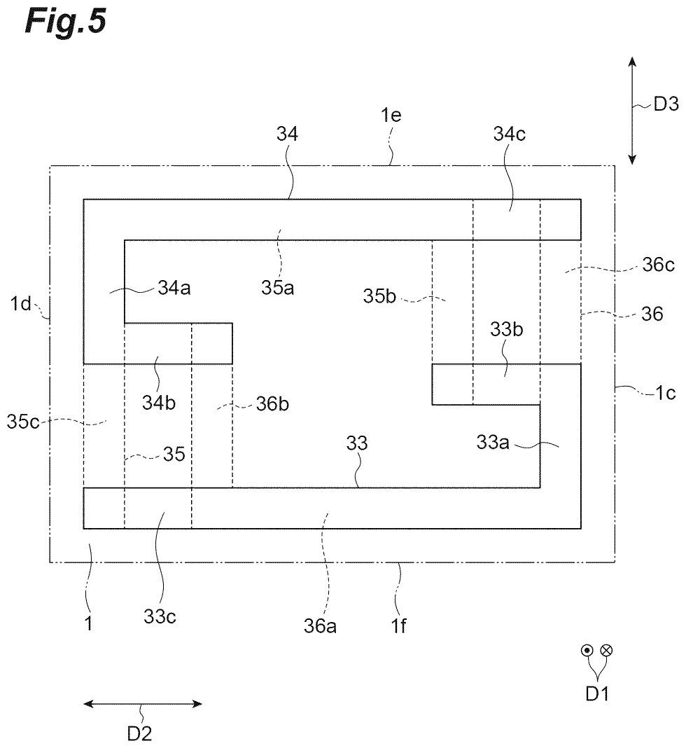

As illustrated in FIG. 5, the coil conductors 33 and 34 are adjacent to the coil conductors 31 and 32 in the first direction D1. The coil conductor 33 is connected to the coil conductor 31. The coil conductor 33 is electrically connected to the coil conductor 31. The coil conductor 33 is electrically connected to the coil conductor 31 through the connection conductor 41. The coil conductor 34 is separated from the coil conductor 33. The coil conductor 34 is connected to the coil conductor 32. The coil conductor 34 is electrically connected to the coil conductor 32. The coil conductor 34 is electrically connected to the coil conductor 32 through the connection conductor 41.

The coil conductor 33 includes a portion 33a, a portion 33b, and a portion 33c. The portion 33a is adjacent to the side surface 1c and is arranged to extend along the side surface 1c. The portion 33b is continuous with the portion 33a and is arranged to extend such that the portion 34c is positioned between the portion 33b and the side surface 1e. The portion 33c is continuous with the portion 33a. The portion 33c is adjacent to the side surface 1f and is arranged to extend along the side surface 1f. The portion 33c is closer to the side surface 1f than the portion 33b. The portion 33b is connected to the coil conductor 31. The portion 33b is electrically connected to the coil conductor 31. The portion 33b is electrically connected to the coil conductor 31 through the connection conductor 41. For example, the portion 33b and the portion 31b are connected to each other through the connection conductor 41. The portion 33b and the portion 31b intersect with each other when viewed from the first direction D1. An intersection angle between the portion 33b and the portion 31b in a connection region of the portion 33b and portion 31b is, for example, larger than 180 degrees when measured inside the coil conductors.

The coil conductor 34 includes a portion 34a, a portion 34b, and a portion 34c. The portion 34a is adjacent to the side surface 1d and is arranged to extend along the side surface 1d. The portion 34b is continuous with the portion 34a and is arranged to extend such that the portion 33c is positioned between the portion 34b and the side surface 1f. The portion 34c is continuous with the portion 34a. The portion 34c is adjacent to the side surface 1e and is arranged to extend along the side surface 1e. The portion 34c is closer to the side surface 1e than the portion 34b. The portion 34c is connected to the coil conductor 32. The portion 34c is electrically connected to the coil conductor 32. The portion 34c is electrically connected to the coil conductor 32 through the connection conductor 41. For example, the portion 34c and the portion 32b are connected to each other through the connection conductor 41.

The portion 32a is arranged to extend to overlap with the portion 33a in the first direction D1. The portion 32b is adjacent to the portion 31b of the coil conductor 31 in the second direction D2, and is exposed from the coil conductors 33 in the first direction D1. The portion 33b is arranged to extend to overlap with the portion 31b. The portion 33b includes a region that is adjacent to the portion 34c in the third direction D3 and exposed from the coil conductors 32 in the first direction D1. The portion 34c is arranged to extend to overlap with the portion 31b. The portion 34c is arranged to extend to overlap with the portion 31a in the first direction D1. The portion 34c includes a region that is adjacent to the portion 33b in the third direction D3 and exposed from the coil conductors 31 in the first direction D1. The portion 31b overlaps with the portion 33b when viewed from the first direction D1 and is electrically connected to the portion 33b.

For example, as illustrated in FIG. 4, when viewed from the first direction D1, an outer edge of the coil conductor 31 includes a portion overlapping with outer edges of the coil conductors 33 and 34. When viewed from the first direction D1, the outer edge of the coil conductor 31 may not include a portion overlapping with the outer edges of the coil conductors 33 and 34. For example, a width of the coil conductor 31 may be equal to widths of the coil conductors 33 and 34. When viewed from the first direction D1, an outer edge of the coil conductor 32 includes a portion overlapping with the outer edges of the coil conductors 33 and 34. When viewed from the first direction D1, the outer edge of the coil conductor 32 may not include a portion overlapping with the outer edges of the coil conductors 33 and 34.

For example, the coil 30 includes at least one unit G1 including the coil conductor layer L2 and the coil conductor layer L3. The at least one unit G1 includes a plurality of units G1. In a configuration in which the coil 30 includes the plurality of unit G1, in the units G1 adjacent to each other, for example, the coil conductor layer L3 included in one unit G1 and the coil conductor layer L2 included in an other unit L2 are adjacent to each other. The coil 30 includes the coil conductor layer L4. The coil conductor layer L4 is adjacent to the main surface 1b. The coil conductor layer L4 includes a coil conductor 37. The coil conductor layer L3 is positioned closest to the main surface 1b of the coil conductor layers L2 and L3 included in the unit G1. The coil conductor layer L3 positioned closest to the main surface 1b is adjacent to the coil conductor layer L4. In the configuration in which the coil 30 includes the plurality of units G1, for example, the coil conductor layer L3 included in the unit G1 positioned closest to the main surface 1b is adjacent to the coil conductor layer L4. The coil conductor layer L3 positioned closest to the main surface 1b is connected to the coil conductor layer L4. The coil conductor layer L3 positioned closest to the main surface 1b is electrically connected to the coil conductor layer L4. For example, the coil conductors 35 and 36 are adjacent to the coil conductor 37 in the first direction D1. The coil conductor 37 includes, for example, one end electrically connected to the coil conductor 35 and an other end electrically connected to the coil conductor 36.

For example, as illustrated in FIG. 5, when viewed from the first direction D1, the outer edge of the coil conductor 33 includes a portion overlapping with outer edges of the coil conductors 35 and 36. When viewed from the first direction D1, the outer edge of the coil conductor 33 may not include a portion overlapping with the outer edges of the coil conductors 35 and 36. For example, the width of the coil conductor 33 may be equal to widths of the coil conductors 35 and 36. When viewed from the first direction D1, the outer edge of the coil conductor 34 includes a portion overlapping with the outer edges of the coil conductors 35 and 36. When viewed from the first direction D1, the outer edge of the coil conductor 34 may not include a portion overlapping with the outer edges of the coil conductors 35 and 36. For example, the width of the coil conductor 34 may be equal to the widths of the coil conductors 35 and 36.

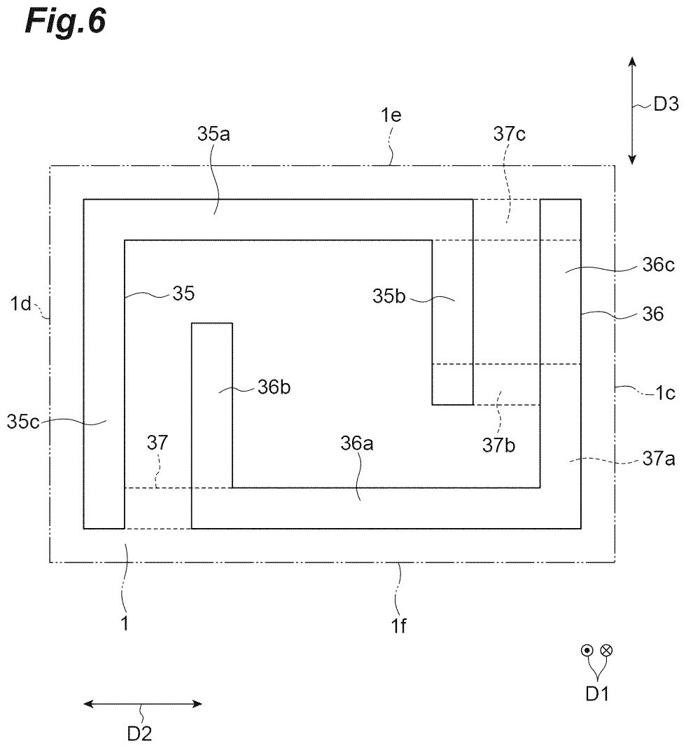

As illustrated in FIG. 6, the coil conductor 35 includes a portion 35a, a portion 35b, and a portion 35c. The portion 35a is adjacent to the side surface 1e and is arranged to extend along the side surface 1e. The portion 35b is continuous with the portion 35a and is arranged to extend such that the portion 36c is positioned between the portion 35b and the side surface 1c. The portion 35c includes a region adjacent to the side surface 1d and arranged to extend along the side surface 1d. The portion 35c is closer to the side surface 1d than the portion 35b.

The portion 35b may be connected to the portion 37b. The portion 35b may be electrically connected to the portion 37b. The portion 35b may be connected to the portion 37b through the connection conductors 41. In the configuration in which the coil 30 includes the plurality of units G1, the portion 35b may be connected to the portion 33b of the coil conductor 33 included in the adjacent coil conductor layer L3. In the configuration in which the coil 30 includes the plurality of units G1, the portion 35b may be electrically connected to the portion 33b of the coil conductor 33 included in the adjacent coil conductor layer L3. In the configuration in which the coil 30 includes the plurality of units G1, the portion 35b may be connected to the portion 33b of the coil conductor 33 included in the adjacent coil conductor layer L3 through the connection conductors 41. The portion 35c is connected to the portion 33c. The portion 35c is electrically connected to the portion 33c. The portion 35c is connected to the portion 33c through a connection conductor 41.

The coil conductor 36 includes a portion 36a, a portion 36b, and a portion 36c. The portion 36a is adjacent to the side surface 1f and is arranged to extend along the side surface 2f. The portion 36b is continuous with the portion 36a and is arranged to extend such that the portion 35c is positioned between the portion 36b and the side surface 1d. The portion 36c includes a region adjacent to the side surface 1c and arranged to extend along the side surface 1c. The portion 36c is closer to the side surface 1c than the portion 36b.

The portion 36b is connected to the portion 34b. The portion 36b is electrically connected to the portion 34b. The portion 36b is connected to the portion 34b through the connection conductors 41. The portion 36b and the portion 34b intersect with each other when viewed from the first direction D1. An intersection angle between the portion 36b and the portion 34b in a connection region of the portion 36b and portion 34b is, for example, larger than 180 degrees when measured inside the coil conductors. The portion 36c may be connected to the portion 37c. The portion 36c may be electrically connected to the portion 37c. The portion 36c may be connected to the portion 37c through the connection conductors 41. In the configuration in which the coil 30 includes the plurality of units G1, the portion 36c may be connected to the portion 34c of the coil conductor 34 included in the adjacent coil conductor layer L2. In the configuration in which the coil 30 includes the plurality of units G1, the portion 36c may be electrically connected to the portion 34c of the coil conductor 34 included in the adjacent coil conductor layer L2. In the configuration in which the coil 30 includes the plurality of units G1, the portion 36c may be connected to the portion 34c of the coil conductor 34 included in the adjacent coil conductor layer L2 through a connection conductor 41.

For example, as illustrated in FIG. 5, the portion 33b is arranged to extend in the second direction D2, and the portion 35b is arranged to extend in the third direction D3. Therefore, the portion 33b and the portion 35b intersect with each other when viewed from the first direction D1. An intersection angle between the portion 33b and the portion 35b in a connection region of the portion 33b and portion 35b is, for example, larger than 180 degrees when measured inside the coil conductors.

For example, the portion 33b may include a region that is continuous with the portion 33a and is arranged to extend in the second direction D2, and a connection region that is continuous with the region arranged to extend in the second direction D2 and is arranged to extend a direction intersecting the second direction D2 such that an end of the connection region approaches the side surface 1e and is directed toward the portion 35b. The portion 35b may include a region that is continuous with the portion 35a and is arranged to extend in the third direction D3, and a connection region that is continuous with the region arranged to extend in the third direction D3 and is arranged to extend a direction intersecting the third direction D3 such that an end of the connection region approaches the side surface 1c and is directed toward the portion 33b. A direction in which the connection region of the portion 33b extends and a direction in which the connection region of the portion 35b extends are, for example, substantially parallel to each other. The connection region of the portion 33b and the connection region of the portion 35b overlap with each other when viewed from the first direction D1. An intersection angle between the connection region of the portion 33b and the connection region of the portion 35b is, for example, approximately 180 degrees.

As illustrated in FIG. 6, the coil conductors 37 each include a portion 37a, a portion 37b, and a portion 37c. The portion 37a is adjacent to the side surface 1c and is arranged to extend along the side surface 1c. The portion 37b is continuous with the portion 37a and is arranged to extend such that the portion 37c is positioned between the portion 37b and the side surface 1e. The portion 37c is continuous with the portion 37a. The portion 37c includes a region adjacent to the side surface 1e and arranged to extend along the side surface 1e. The portion 37c is closer to the side surface 1e than the portion 37b. The portion 37c includes a region that overlaps with the portion 35a in the first direction D1 and is exposed from the coil conductors 35.

The portion 37b overlaps with the portion 35b when viewed from the first direction D1. The portion 37b is connected to the portion 35b. The portion 37b is electrically connected to the portion 35b. The portion 37b is connected to the portion 35b through the connection conductors 41. The portion 37b and the portion 35b intersect with each other when viewed from the first direction D1. An intersection angle between the portion 37b and the portion 35b in a connection region of the portion 37b and portion 35b is, for example, larger than 180 degrees when measured inside the coil conductors. When viewed from the first direction D1, the portion 37c overlaps with the portion 36c and is connected to the portion 36c. The portion 37c is electrically connected to the portion 36c. The portion 37c is connected to the portion 36c through the connection conductors 41.

For example, as illustrated in FIG. 6, when viewed from the first direction D1, the outer edge of the coil conductor 35 includes a portion overlapping with an outer edge of the coil conductor 37. When viewed from the first direction D1, the outer edge of the coil conductor 35 may not include a portion overlapping with the outer edge of the coil conductor 37. For example, the width of the coil conductor 35 may be equal to a width of the coil conductor 37. When viewed from the first direction D1, the outer edge of the coil conductor 36 includes a portion overlapping with the outer edge of the coil conductor 37. When viewed from the first direction D1, the outer edge of the coil conductor 36 may not include a portion overlapping with the outer edge of the coil conductor 37. For example, the width of the coil conductor 36 may be equal to the width of the coil conductor 37. In FIGS. 4 to 6, a two-dot chain line schematically illustrates a part of an outline of the outer shape of the element body 1. In FIGS. 4 to 6, hatching indicating a cross section of the element body 1 is omitted.

For example, when the portion 33c includes a first portion, the portion 34a includes a second portion, and the portion 34b includes a third portion. For example, when the portion 35c includes a fourth portion, the portion 36a includes a fifth portion, and the portion 36b includes a sixth portion. For example, when the portion 34a includes a second portion, the portion 34c includes a seventh portion. For example, when the portion 33c includes a first portion, the portion 33a includes an eighth portion, and the portion 33b includes a ninth portion. For example, when the portion 34c includes a seventh portion, the portion 32b includes a tenth portion. For example, when the portion 33b includes a ninth portion, the portion 31a includes an eleventh portion, and the portion 31b includes a twelfth portion.

The coil 30, the connection conductor 41, and the connection conductors 42 and 43 include an electrically conductive material. The electrically conductive material includes, for example, Ag, Pd, Au, Cu, or Al. The electrically conductive material includes, for example, Ag—Pd alloy, Ag—Cu alloy, Ag—Au alloy, or Ag—Pt alloy. The coil 30, the connection conductor 41, and the connection conductors 42 and 43 include, for example, the same electrically conductive material as the external electrodes 10 and 20. The coil 30, the connection conductor 41, and the connection conductors 42 and 43 may include an electrically conductive material different from that of the external electrodes 10 and 20. In a configuration in which the coil component ED1 includes the through-hole conductor and the pad conductor, the through-hole conductor and the pad conductor include, for example, the above-described electrically conductive material.

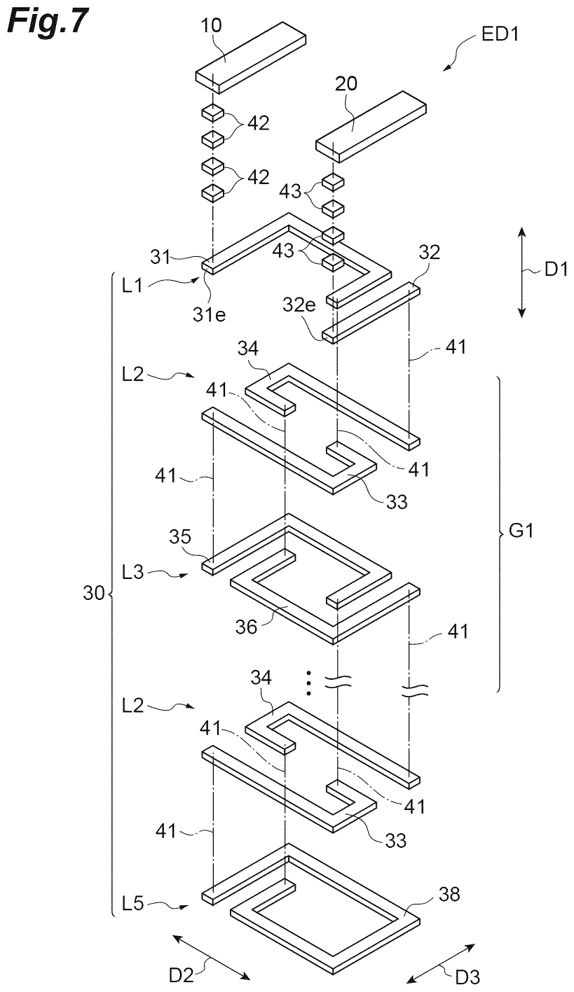

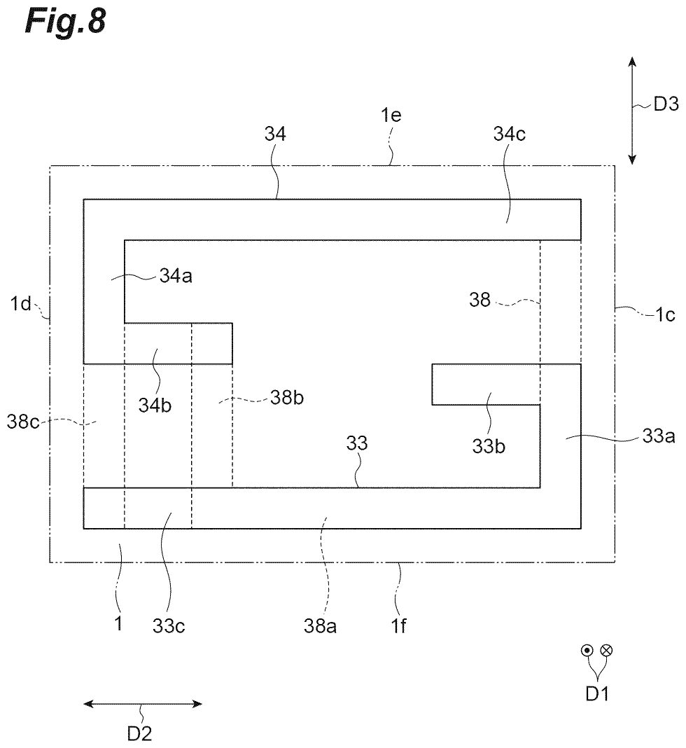

A configuration of a modified example of the coil component ED1 according to the example will be described with reference to FIGS. 7 and 8. FIG. 7 is an exploded perspective view illustrating a coil and a connection conductor. FIG. 8 is a view illustrating a cross-sectional configuration of a coil component according to a modified example of the example. The coil component ED1 according to this modified example is generally similar to or the same as the coil component ED1 according to the example. However, the coil component ED1 according to this modified example is different from the coil component ED1 according to the example in a configuration of the coil conductors. Hereinafter, differences between the above-described example and this modified example will be mainly described. The coil component ED1 according to the modified example includes coil conductors 33, 34, and 38 instead of the coil conductor 37 included in the coil component ED1 according to the above-described example. The coil conductor 38 is adjacent to the main surface 1b. The coil conductors 33 and 34 are adjacent to the coil conductor 38. The coil conductor 38 is positioned between the coil conductors 33 and 34 and the main surface 1b in the first direction D1. The coil conductors 33 and 34 adjacent to the coil conductor 38 may be included in the coil conductor layer L2.

The coil 30 includes the coil conductors 33 and 34 such that the coil conductors 35 and 36 are positioned closer to the main surface 1a than the coil conductors 33 and 34 in the first direction D1. The coil conductor 33 is adjacent to the coil conductor 34 in the third direction D3 and is connected to the coil conductor 35. The coil conductor 33 is electrically connected to the coil conductor 35. The coil conductor 34 is adjacent to the coil conductor 33 in the third direction D3 and is connected to the coil conductor 36. The coil conductor 34 is electrically connected to the coil conductor 36.

The coil conductor 33 is electrically connected to the coil conductor 38. The coil conductor 33 is electrically connected to the coil conductor 38 through the connection conductor 41. The coil conductor 34 is electrically connected to the coil conductor 38. The coil conductor 34 is electrically connected to the coil conductor 38 through the connection conductor 41.

As illustrated in FIG. 8, the coil conductor 38 includes a portion 38a, a portion 38b, and a portion 38c. The portion 38a is adjacent to the side surface 1f and arranged to extend along the side surface 1f. The portion 38b is continuous with the portion 38a and arranged to extend such that the portion 38c is positioned between the portion 38b and the side surface 1d. The portion 38c is continuous with the portion 38a. The portion 38c includes a region adjacent to the side surface 1d and arranged to extend along the side surface 1d. The portion 38c is closer to the side surface 1d than the portion 38b.

The portion 38c includes a region that overlaps with the portion 34a in the first direction D1 and is exposed from the coil conductor 34. The portion 38b overlaps with the portion 34b when viewed from the first direction D1. The portion 38b is connected to the portion 34b. The portion 38b is electrically connected to the portion 34b. The portion 38b is connected to the portion 34b through the connection conductors 41. The portion 38c overlaps with the portion 33c when viewed from the first direction D1. The portion 38c is connected to the portion 33c. The portion 38c is electrically connected to the portion 33c. The portion 38c is connected to the portion 33c through the connection conductors 41.

For example, as illustrated in FIG. 8, when viewed from the first direction D1, the outer edges of the coil conductors 33 and 34 include portions overlapping with an outer edge of the coil conductor 38. When viewed from the first direction D1, the outer edges of the coil conductors 33 and 34 may not include portions overlapping with the outer edge of the coil conductor 38. For example, the widths of the coil conductors 33 and 34 may be equal to a width of the coil conductor 38. In FIG. 8, a two-dot chain line schematically illustrates a part of the outline of the outer shape of the element body 1. In FIG. 8, hatching indicating a cross section of the element body 1 is omitted.

As described above, in the coil component ED1, the coil 30 includes the coil conductor layers L2 and L3. The coil conductor layer L2 includes the coil conductors 33 and 34. The coil conductor layer L3 includes the coil conductors 35 and 36. Each of the coil conductor layers L2 and L3 included in the coil 30 includes the plurality of coil conductors electrically connected to the external electrodes 10 and 20. The coil component ED1 may increase the number of turns of the coil 30.

In the coil component ED1, the portion 36c is arranged to extend along the side surface 1c, and the portion 33a is arranged to extend to overlap with the portion 36c in the first direction D1. The portion 35a is arranged to extend along the side surface 1e, and the portion 34c is adjacent to the side surface 1e and is arranged to extend to overlap with the portion 35a in the first direction D1. The coil component ED1 may increase an inner diameter of the coil 30.

In the coil component ED1, the portion 35b is arranged to extend such that the portion 36c is positioned between the portion 35b and the side surface 1c, and the portion 33b is arranged to extend such that the portion 34c is positioned between the portion 33b and the side surface 1e. Therefore, the coil component ED1 reliably maintains a connection between the portion 36c and the portion 34c.

In the coil component ED1, the portion 36c and the portion 34c are connected through the connection conductor 41.

The coil component ED1 reliably maintains the connection between the portion 36c and the portion 34c.

In the coil component ED1, the element body 1 includes the side surface 1d opposing the side surface 1c and the side surface 1f opposing the side surface 1e. The coil 30 includes the coil conductor layer L1 including the coil conductor 33 and the coil conductor 34 that are separated from each other, the coil conductor layer L1 being disposed adjacent to the coil conductor layer L2 in the first direction D1 and being disposed such that the coil conductor layer L2 is positioned between the coil conductor layer L1 and the coil conductor layer L3. The coil conductor 35 includes the portion 35c continuous with the portion 35a, the portion 35c being adjacent to the side surface 1d and arranged to extend along the side surface 1d. The coil conductor 36 includes: the portion 36a continuous with the portion 36c, the portion 36a being adjacent to the side surface 1f and arranged to extend along the side surface 1f; and the portion 36b continuous with the portion 36a and arranged to extend such that the portion 35c is positioned between the portion 36b and the side surface 1d. The coil conductor 33 includes the portion 33c adjacent to the side surface 1f and arranged to extend to overlap with the portion 36a in the first direction D1. The coil conductor 34 includes: the portion 34a adjacent to the side surface 1d and arranged to extend to overlap with the portion 35c in the first direction D1; and the portion 34b continuous with the portion 34a and arranged to extend to overlap with the portion 36b in the first direction D1 and to extend such that the portion 33c is positioned between the portion 34b and the side surface 1f. The portion 36b and the portion 34b are connected through the connection conductor 41.

The coil component ED1 may further increase the inner diameter of the coil 30.

In the coil component ED1, the portion 35c and the portion 33c are connected through the connection conductor 41.

The coil component ED1 reliably maintains the connection between the portion 35c and the portion 33c.

In the coil component ED1, the coil 30 includes the coil conductor layer L1 including the pair of coil conductors 31 and 32 that are separated from each other, the coil conductor layer L1 being adjacent to the main surface 1a. The coil conductor 31 is positioned at the one end 30e1 of the coil 30 and is connected to the external electrode 10 through the connection conductor 42. The coil conductor 32 is positioned at the other end 30e2 of the coil 30 and is connected to the external electrode 20 through the connection conductor 43.

In the coil component ED1, the connection conductor 42 and the connection conductor 43 may have a thickness in the first direction D1 that is smaller than a thickness in the first direction D1 of each of the coil conductors 31, 32, 33, 34, 35, and 36. A decrease in the thicknesses of the connection conductor 42 and the connection conductor 43 in the first direction D1 may more reliably increase the number of the turns of the coil 30.

In the coil component ED1, the distance H1 and the distance H2 are equal to each other.

The coil component ED1 may make a length of the connection conductor 42 in the first direction D1 equal to a length of the connection conductor 43 in the first direction D1. For example, the length of the connection conductor 42 in the first direction D1 and the length of the connection conductor 43 in the first direction D1 are equal to each other.

In the coil component ED1, the connection conductor 42 and the connection conductor 43 are next to the side surface 1f.

The coil component ED1 may increase a length of each of the coil conductors 31 and 32, as compared with, for example, a configuration in which the connection conductor 42 and the connection conductor 43 are next to different side surfaces. Therefore, the coil component ED1 may improve inductance of the coil 30.

It is to be understood that not all aspects, advantages and features described herein may necessarily be achieved by, or included in, any one particular example. Indeed, having described and illustrated various examples herein, it should be apparent that other examples may be modified in arrangement and detail.

In the coil component ED1, the distance H1 and the distance H2 may not be equal to each other. The configuration in which the distance H1 is equal to the distance H2, as described above, may make a length of the connection conductor 42 in the first direction D1 equal to a length of the connection conductor 43 in the first direction D1.

In the coil component ED1, the connection conductors 42 and 43 may not be next to one side surface among the plurality of side surfaces. The configuration in which the connection conductor 42 and the connection conductor 43 are next to the one side surface, as described above, may increase a length of each of the coil conductors 31 and 32, as compared with, for example, a configuration in which each of the connection conductor 42 and the connection conductor 43 are next to different side surfaces. Therefore, the configuration in which the connection conductor 42 and the connection conductor 43 are next to the one side surface may improve the inductance of the coil 30.

What is claimed is:

1. A coil component comprising:
an element body including a first main surface, a second main surface opposing the first main surface, and a plurality of side surfaces coupling the first main surface and the second main surface;
a first external electrode and a second external electrode disposed on the first main surface and separated from each other; and
a coil disposed in the element body and including a plurality of coil conductor layers electrically connected to the first external electrode and the second external electrode, wherein
the plurality of side surfaces include a first side surface and a second side surface adjacent to each other,
the plurality of coil conductor layers include:
a first coil conductor layer including a first coil conductor and a second coil conductor separated from each other; and
a second coil conductor layer adjacent to the first coil conductor layer in a direction perpendicular to the first main surface and including a third coil conductor and a fourth coil conductor separated from each other,
the first coil conductor includes a first portion adjacent to the first side surface and arranged to extend along the first side surface,
the second coil conductor includes:
a second portion adjacent to the second side surface and arranged to extend along the second side surface; and
a third portion continuous with the second portion and arranged to extend such that the first portion is positioned between the third portion and the first side surface,
the third coil conductor includes a fourth portion adjacent to the second side surface and arranged to extend to overlap with the second portion in the direction perpendicular to the first main surface,
the fourth coil conductor includes:
a fifth portion adjacent to the first side surface and arranged to extend to overlap with the first portion in the direction perpendicular to the first main surface; and
a sixth portion continuous with the fifth portion and arranged to extend to overlap with the third portion in the direction perpendicular to the first main surface and to extend such that the fourth portion is positioned between the sixth portion and the second side surface, and
the third portion and the sixth portion are connected through a connection conductor.

2. The coil component according to claim 1, wherein
the first portion and the fourth portion are connected through a connection conductor.

3. The coil component according to claim 1, wherein
the plurality of side surfaces further include a third side surface opposing the first side surface and a fourth side surface opposing the second side surface,
the plurality of coil conductor layers include an other coil conductor layer including a fifth coil conductor and a sixth coil conductor that are separated from each other, the other coil conductor layer being disposed adjacent to the first coil conductor layer in the direction perpendicular to the first main surface and being disposed such that the first coil conductor layer is positioned between the other coil conductor layer and the second coil conductor layer,
the second coil conductor includes a seventh portion continuous with the second portion, the seventh portion being adjacent to the third side surface and arranged to extend along the third side surface,
the first coil conductor includes:
an eighth portion continuous with the first portion, the eighth portion being adjacent to the fourth side surface and arranged to extend along the fourth side surface; and
a ninth portion continuous with the eighth portion and arranged to extend such that the seventh portion is positioned between the ninth portion and the third side surface,
the fifth coil conductor includes a tenth portion adjacent to the fourth side surface and arranged to extend to overlap with the eighth portion in the direction perpendicular to the first main surface,
the sixth coil conductor includes:
an eleventh portion adjacent to the third side surface and arranged to extend to overlap with the seventh portion in the direction perpendicular to the first main surface; and
a twelfth portion continuous with the eleventh portion and arranged to extend to overlap with the ninth portion in the direction perpendicular to the first main surface and to extend such that the tenth portion is positioned between the twelfth portion and the fourth side surface,
the ninth portion and the twelfth portion are connected through a connection conductor.

4. The coil component according to claim 3, wherein
the seventh portion and the tenth portion are connected through a connection conductor.

5. The coil component according to claim 1, wherein
the plurality of coil conductor layers include a third coil conductor layer including a pair of coil conductors that are separated from each other, the third coil conductor layer being adjacent to the first main surface,
one coil conductor of the pair of coil conductors is positioned at one end of the coil and is connected to the first external electrode through a connection conductor, and an other coil conductor of the pair of coil conductors is positioned at an other end of the coil and is connected to the second external electrode through a connection conductor.

6. The coil component according to claim 5, wherein
a distance between the one coil conductor and the first external electrode in the direction perpendicular to the first main surface and a distance between the other coil conductor and the second external electrode in the direction perpendicular to the first main surface are equal to each other.

7. The coil component according to claim 5, wherein
the connection conductor arranged to connect the one coil conductor and the first external electrode and the connection conductor arranged to connect the other coil conductor and the second external electrode are next to one side surface of the plurality of side surfaces.
